(19) United States
(12) Patent Application Publication
(10) Pub. No.: US 2017/0168680 A1
(43) Pub. Date: Jun. 15, 2017

(54) DEVICE AND A METHOD FOR ASSISTING THE PILOTING OF AN AIRCRAFT

(71) Applicant: AIRBUS HELICOPTERS, Marignane (FR)

(72) Inventors: Romain FOURNEAU-PELLETIER, Aix En Provence (FR); Roland TOUATI, Salon De Provence (FR); Valerie JUPPET, Vitrolles (FR)

(73) Assignee: AIRBUS HELICOPTERS, Marignane (FR)

(21) Appl. No.: 15/376,017

(22) Filed: Dec. 12, 2016

(30) Foreign Application Priority Data
Dec. 15, 2015 (FR) 1502591

(51) Int. Cl. G06F 3/0481; G06F 17/30; G06F 3/0482; B64D 43/00; G06F 3/0484

(52) U.S. Cl. CPC G06F 3/04817; B64D 43/00; G06F 3/04845; G06F 3/0482; G06F 17/3056; G06F 3/0488

(57) ABSTRACT

A device and a method for assisting the piloting of an aircraft. The device comprises at least one touch screen, a memory containing a database, measurement and detection means, and analysis means. The measurement and detection means and the analysis means determine a current situation of the aircraft. Each touch screen displays two pages of information, at least one main permanent icon independent of the current situation, and at least one main contextual icon relating to an event of the current situation. Each touch screen enables a main contextual icon to be selected and then dragged sideways in order to display a page of information attached to an event of the current situation. The touch screen also enables a main permanent icon to be selected in order to display a main page of information.

### CROSS REFERENCE TO RELATED APPLICATION

This application claims priority to French patent application No. FR 15 02591 filed on Dec. 15, 2015, the disclosure of which is incorporated in its entirety by reference herein.

### BACKGROUND OF THE INVENTION

(1) Field of the Invention

The present invention relates to the field of devices for assisting the piloting of aircraft.

The present invention relates to a device for assisting the piloting of an aircraft and to a method of assisting the piloting of an aircraft.

(2) Description of Related Art

During a flight, the crew of an aircraft needs a large amount of information, which information relates in particular to the conduct of the flight, to the state of the aircraft, and also to the state of the aircraft's environment. This information is provided by monitor means such as flight instruments, and/or display means such as screens, present on the instrument panel of the aircraft. The crew generally comprises a pilot and a copilot. The information is thus usually supplied in duplicate and identically, both for the pilot and for the copilot of the aircraft.

Furthermore, the functions and the pieces of equipment that are available on board an aircraft are numerous and the numbers of them continue to increase on new aircraft. Additional information relating to these functions and to these pieces of equipment must therefore also be supplied to the crew of the aircraft.

Nevertheless, only limited area is available on the instrument panel or in the cockpit of an aircraft for installing monitoring means and display means, in particular because of the need to conserve a sufficient area of visibility to the outside of the aircraft. The installation of such monitoring and display means must also enable them to be readable and accessible for the pilot and/or the copilot of the aircraft.

In contrast, the increase in the number of such monitoring and display means leads to an increase in the cost and in the weight associated with such monitoring and display means.

Furthermore, supplying a large amount of information simultaneously to the crew of an aircraft does not necessarily facilitate managing and using the aircraft. Specifically, the crew cannot take cognizance of and take into account all of that information simultaneously while also concentrating on piloting the aircraft. Furthermore, in certain emergency conditions, it can be difficult for the crew to find quickly the pertinent information necessary for managing the emergency situation from the multitude of information made available. By way of example, such an emergency situation may be a failure or a fire in a piece of equipment of the aircraft, e.g. an engine.

Furthermore, aviation regulations require certain kinds of information deemed to be necessary or essential for proper safe conduct of a flight of an aircraft to be displayed permanently. Such regulatory requirements also limit the space available for displaying any other information. By way of example, such information comprises primary piloting parameters such as the attitude, the altitude, and the speed of the aircraft, together with information describing the operation of the engine(s) of the aircraft, e.g. the pressure and the temperature of the engine oil.

In modern aircraft, the pilot and the copilot generally have respective screens for displaying various pages of information. The pilot and the copilot can act independently to change one or the other of the pages of information on display on their respective screens and thus browse among different pages of information.

For reasons of simplification, the term “pilot” is used on its own below to cover equally well the pilot and the copilot, with the actions of the pilot and of the copilot being identical in the context of the invention.

These pages of information can replace the flight instruments conventionally used on an aircraft and they can provide information about the state of the aircraft and its environment, such as, for example, the speed, the altitude, or indeed the attitude of the aircraft. These pages of information may also supply information about the conduct of the flight or indeed about the operation of the aircraft and the operation of its equipment.

These pages of information are linked to one another by means of a simple and predefined primary tree structure. The primary tree structure corresponds to the pages of information being organized and classified in logical and hierarchical manner by using a tree-and-branch algorithmic structure. The pages of information are classified as main pages of information when situated at a main level of the primary tree structure, and as secondary pages of information when situated at secondary levels of the primary tree structure. Thus, each branch of the primary tree structure begins with a main page of information and is followed at one or more secondary levels with secondary pages of information.

On each main page of information, one or more secondary icons are displayed, each secondary icon corresponding to a secondary page of information that is to be found at the first secondary level immediately below the main level of the primary tree structure and on the same branch as the main page of information. Thus, the pilot can request the display of a secondary page of information by selecting a secondary icon.

Likewise, on each secondary page of information, one or more secondary icons are displayed, each secondary icon corresponding to a secondary page of information that is to be found at a secondary level of the primary tree structure immediately below the secondary level of the secondary page of information that is being displayed and on the same branch as this displayed secondary page of information. Thus, the pilot can request the display of a secondary page of information by selecting a secondary icon.

Furthermore, main icons are displayed on each main page of information and on each secondary page of information. Each main icon corresponds to a main page of information at the main level of the primary tree structure. Thus, by selecting a main icon, the pilot can request the display of a main page of information at any time while browsing the primary tree structure.

The primary tree structure thus enables pages of information to be consulted effectively in compliance with the classification and hierarchy of the primary tree structure. Nevertheless, the display of a secondary page of information is accessible only by following a single path through the primary tree structure, starting from a single main page of information.

As a result, in order to consult in succession two secondary pages of information that are not situated on the same branch of the primary tree structure, the pilot needs to go back via a display of a main page of information. Such an operation can require a greater or lesser length of time, particularly if the secondary page of information is located at the end of a branch.

Specifically, the primary tree structure is defined in order to provide a compromise between the depth of the primary tree structure, i.e. the number of secondary levels, and the number of links that are directly available on each main secondary page of information, i.e. the number of secondary permanent icons that are displayed on each page of information. By way of example, the primary tree structure and possibly the content of the main and secondary pages of information are classified and organized hierarchically on the basis of a particular vision of the aircraft as a system of a particular vision of the functions of the aircraft, or indeed of a particular vision of the operational tasks to be performed by the aircraft. It is difficult for such a primary tree structure to take account of all of these visions simultaneously. Consequently, browsing between main and secondary pages of information can be optimized but only for a single vision as the basis for the primary tree structure, e.g. corresponding to a vision of the aircraft as a system, such that browsing becomes more tedious and more laborious if the pilot seeks to browse among pages of information using a vision of the functions of the aircraft, or indeed using a vision of the operational tasks that are to be performed by the aircraft.

Specifically, it can be necessary for the pilot to perform numerous selection actions through the primary tree structure when seeking to display a secondary page of information that is situated on a branch that is different from the branch of the secondary page of information that is currently being displayed. Furthermore, this risk increases with an increasing number of secondary pages of information associated with introducing new functions and/or new pieces of equipment in the aircraft.

Furthermore, much of the information necessary for operating the aircraft and its equipment is present only in the flight and/or user manuals of the aircraft and its equipment. These manuals are presently available in paper form or in electronic form, but without any connection with the display means of the aircraft. Consequently, this information cannot generally be displayed in the form of pages of information on the display means of the aircraft.

By way of example, such flight and/or user manuals contain sheets describing equipment of the aircraft and how it operates. Such flight and/or user manuals also contain information about managing certain flight situations or certain incidents, e.g. a failure or a fire involving one or more pieces of equipment, which information also includes the procedures to be followed and/or lists of tasks to be undertaken.

Specifically, if the pilot is not sure about the operation of a piece of equipment or indeed about the procedure to be followed and the tasks to be undertaken in a given flight situation or incident, the pilot needs to consult the aircraft manual, e.g. manually and while in flight, in order to find pertinent information about the situation or the incident. Searching through the numerous pages of the manual can be lengthy and tedious, and might for example delay starting an emergency procedure. Such searching may be made easier and quicker with an electronic version of the flight manual, but without that enabling all of the pertinent information to be found immediately.

Nevertheless, Document EP 0 580 474 describes a method and a device that provide the crew of an aircraft with information that is adapted to the current situation of the aircraft. That information comes from a database that groups together a large quantity of information contained in documents that are generally present in paper form in the aircraft. By way of example, those documents might be flight manuals, the maintenance manual, and maps.

Furthermore, Document FR 3 012 599 describes a method of displaying information about the operation of an aircraft as a function of a trigger event, which may be a change of state of any kind in a component of the aircraft or indeed in the aircraft itself. A master indicator is displayed, e.g. representing the state of the component in the form of an icon displayed on a touch screen, or a mechanical button may be illuminated. Thereafter, a user input, in the form of manual action on the icon or on the mechanical button leads to additional information being displayed, e.g. new icons, a check list to be executed relating to the trigger event, synoptics to be followed, or indeed graphics. The displayed information may be updated as a function of actions executed by the crew of the aircraft.

That method and device make it possible, in real time, to acquire an event relating to the current situation of the aircraft, to preselect information from the database that is best adapted to that current situation of the aircraft, and possibly to classify the information in order of pertinence. The pilot can then make use of the appropriate and pertinent information about the current situation of the aircraft on a screen.

### BRIEF SUMMARY OF THE INVENTION

An object of the present invention is to be unaffected by the above-mentioned limitations and to propose a device for assisting the piloting of an aircraft and a method of assisting the piloting of an aircraft that make it possible to browse quickly, effectively, and pertinently through the main and secondary pages of information available in a database as a function of the current situation of the aircraft.

In this context, the present invention provides a device for assisting the piloting of an aircraft, the device comprising:

at least one processor;

at least one display means;

selection means for each display means;

at least one memory containing at least one database;

measurement and detection means; and

at least one analysis means.

This device of the invention for assisting the piloting of an aircraft is for use in aircraft and in particular in rotary wing aircraft.

The measurement and detection means are elements usually present in an aircraft for determining in particular the operating state of the aircraft and of its equipment. By way of example, the measurement and detection means may be sensors serving to determine the speed relative to the air, the altitude, or indeed the attitude of the aircraft. The measurement and detection means may also be sensors for measuring the temperature of an engine or of a main power transmission gearbox of the aircraft, and also the electricity consumption or indeed the hydraulic pressure in a piece of equipment. The measurement and detection means may also include a satellite receiver enabling the speed and the position of the aircraft to be determined relative to the ground in a terrestrial reference frame.

The measurement and detection means may be means dedicated to the device of the invention for assisting the piloting of an aircraft and may constitute a portion of that device for assisting the piloting of an aircraft. The device for assisting the piloting of an aircraft may alternatively make use of measurement and detection means that are already present in the aircraft, i.e. said device means then shares these means with other equipment of the aircraft, such as avionics equipment.

The device of the invention for assisting the piloting of an aircraft may include one or more memories storing one or more databases. By way of example, a first database may comprise main and secondary pages of information that can be displayed on one of the display means. These main and secondary pages of information may be classified hierarchically in a primary tree structure. Another database may be the flight plan of the aircraft, in particular containing the coordinates of waypoints for the intended route and the intended landing point. Another database may also be constituted by maps of zones to be overflown by the aircraft, e.g. including the relief, potential obstacles, and also available landing grounds or platforms.

Each display means may be a screen placed on the instrument panel of the aircraft. Preferably, each display means is a touch screen advantageously incorporating the selection means relating to the display means. Nevertheless, the selection means could be a computer mouse or indeed a touch pad. A pointer is then displayed on the display means and moves depending on movements of the computer mouse or of the pilot's finger on the touch pad, with the display and the movement of the pointer being defined in known manner by means of the processor.

The device of the invention for assisting the piloting of an aircraft is remarkable in that:

the measurement and detection means and at least one analysis means determine a current situation of the aircraft;

at least one display means displays two pages of information, and at least one main contextual icon, each main contextual icon corresponding to an event of the current situation of aircraft; and the selection means of the display means on which at least one main contextual icon is displayed enable a main contextual icon to be selected and then dragged sideways on the display means in order to display a page of information linked to the selected main contextual icon and attached to an event of the current situation of the aircraft.

Each analysis means makes use in real time of the measurement and/or the information provided by the measurement and detection means in order to determine a current situation of the aircraft.

An analysis means can thus determine the stage of flight of the aircraft, e.g. by using the speed, the attitude, and the altitude of the aircraft. The stage of flight of the aircraft, such as a takeoff stage, cruising flight, hovering flight, or indeed a landing stage, thus constitutes an event of the current situation of the aircraft. An event of the current situation of the aircraft may also be a change in stage of flight.

An analysis means can also use the flight plan stored in a memory of the device of the invention to define how the flight of the aircraft is progressing relative to the flight plan. An event of the current situation of the aircraft can thus be passing a waypoint of the flight plan or indeed the aircraft departing from the route intended by the flight plan by a significant distance.

An analysis means may also use the measurements and the information provided by the measurement and detection means to determine an abnormal change in the current situation of the aircraft, in particular in the event of an incident or a failure of a piece of equipment of the aircraft. By way of example, an event of the current situation of the aircraft may be an abnormal variation such as a drop in hydraulic pressure or indeed in the electricity consumption of a piece of equipment. An event of the current situation of the aircraft may also be a failure detected on a piece of equipment of the aircraft, or indeed a fire in a zone of the aircraft, such as an engine compartment.

Each analysis means may use at least one database stored in a memory of the device of the invention and may compare the measurement and information provided by the measurement and detection means with the context of a database in order to determine the current situation of the aircraft and whether an event of the current situation of the aircraft has appeared.

The device for assisting the piloting of an aircraft may have a single analysis means.

The device for assisting the piloting of an aircraft may have a plurality of analysis means that are identical and that are used in parallel in order to mitigate a failure of any one of the analysis means.

The device for assisting the piloting of an aircraft may include a plurality of analysis means that are different from one another and complementary, each analysis means being dedicated to specific situations. By way of example, a first analysis means determines the stage of flight of the aircraft and a second analysis means is dedicated to detecting incidents and failures.

The device for assisting the piloting of an aircraft ensures that at least one display means displays two pages of information and at least one main contextual icon. The two pages of information come from the first database stored in a memory of the device of the invention for assisting the piloting of an aircraft.

Advantageously, each main contextual icon corresponds to an event of the current situation of the aircraft as determined in real time by an analysis means.

A main contextual icon may be displayed for each event of the current situation that is detected as a function of a pre-established list of events.

A main contextual icon may be an operating main contextual icon when the event with which it is attached relates to the normal conduct of the flight of the aircraft. By way of example, an operating main contextual icon may be attached to the progress of the aircraft along the route intended by the flight plan or indeed to a change in stage of flight, e.g. in order to enter into a landing stage. An operating main contextual icon may also be attached to a piece of equipment of the aircraft having availability that depends on the stage of flight of the aircraft. For example, when an event of the current situation of the aircraft is the aircraft undertaking hovering flight and when the aircraft includes winching equipment, an operating main contextual icon corresponding to the winch function is displayed on the display means, this function being usable only during hovering flight.

A main contextual icon may also be an alerting main contextual icon when the event to which it is attached relates to an incident or to a failure of an essential piece of equipment of the aircraft. A piece of equipment is considered as being essential if a failure of that piece of equipment can endanger the safety of the flight of the aircraft. By way of example, an essential piece of equipment is an engine, the main rotor, or indeed retractable landing gear. An alerting main contextual icon may be represented in a particular form or with a particular color in order to be easily identifiable by the pilot of the aircraft.

The pilot can then use the selection means relating to the display means to select a main contextual icon and then drag it sideways. The pilot selects the main contextual icon by using the selection means and then uses the selection means to drag the main contextual icon over the display means. The main contextual icon is dragged over the display means in known manner by the action of the processor responding to the action of the pilot on the selection means. If the display means and the selection means are grouped together to form a touch screen, the pilot presses a finger on the touch screen at the main contextual icon and then moves that finger over the touch screen so as to drag the main contextual icon.

The pilot thus drags the main contextual icon sideways over one of the pages of information being displayed, and the device of the invention for assisting the piloting of an aircraft then displays a new page of information linked to the selected main contextual icon. This new page of information linked to the selection main contextual icon is displayed as a replacement for the page of information that was previously being displayed on the display means.

This new page of information comes from the first database. Advantageously, the new page of information is linked to the selected main contextual icon and is thus attached to the event attached to this selected main contextual icon. The pilot can thus easily and quickly consult a page of information relating to an event of the current situation of the aircraft.

In addition, after the main contextual icon has been selected and the new page of information linked to the selected main contextual icon has been displayed, the device for assisting the piloting of an aircraft enables the display means to display at least one secondary contextual icon. Each secondary contextual icon corresponds likewise to an event of the current situation of the aircraft to which the selected main contextual icon is attached.

The pilot can then use the selection means relating to the display means to select a secondary contextual icon. The device of the invention for assisting the piloting of an aircraft then displays a page of information linked to the selected secondary contextual icon. This page of information linked to the selected secondary contextual icon is displayed as a replacement for the previously-displayed page of information that was linked to the previously-selected main contextual icon. Furthermore, each of the other secondary contextual icons previously on display are also displayed simultaneously with the page of information.

The main and secondary contextual icons preferably enable secondary pages of information to be displayed, e.g. in order to verify the state, the characteristics, or indeed the operation of a piece of equipment of the aircraft relating to an event of the current situation of the aircraft. A plurality of contextual links have previously been created to secondary pages of information, each contextual link being linked to a contextual icon and thus attached to an event of the current situation of the aircraft.

Thus, for a predetermined event of the current situation of the aircraft, a main contextual link is established to a secondary page of information. This secondary page of information is considered as being the page of information that is the most pertinent for being communicated initially to the pilot of the aircraft in order to take account of and/or to handle the event. A main contextual icon is then linked to this main contextual link.

Thereafter, one or more secondary contextual links are set up between this secondary page of information linked to the main contextual link and one or more secondary pages of information. These secondary pages of information are also pertinent for enabling the pilot to take account of and/or handle the event. A secondary contextual icon is then linked to each secondary contextual icon.

As a result, an event of the current situation of the aircraft is associated with a single main contextual icon and at least one secondary contextual icon.

The secondary pages of information come from the first database and in particular they contain information that is conventionally displayed on the screens of aircraft. This information relates in particular to conduct of the flight, to the state of the aircraft, and also to the state of the aircraft's environment.

Advantageously, the secondary pages of information can also be additional information coming from another database. This additional information may for example be the content of flight and user manuals for the aircraft and its equipment. This additional information may also come from maintenance manuals for the aircraft, e.g. making it possible to verify the data and the content of the most recent maintenance operation performed on a piece of equipment.

This additional information may also be a list of tasks to be accomplished and/or procedures to be followed as a function of an event of the current situation of the aircraft. For example, the procedure to be followed and the list of tasks to be accomplished in the event of a fire in the engine compartment while the aircraft is in flight.

Furthermore, this additional information may also be added to the first database.

The main and secondary contextual icons then enable the pilot of the aircraft to display very quickly and at the right moment the appropriate and pertinent information needed for managing the events of the current situation of the aircraft as selected from the multitude of information made available. The events of the current situation of the aircraft may also comprise the appearance of abnormal events such as a failure or an incident on a piece of equipment of the aircraft or indeed a change in the operating stage of flight of the aircraft.

In addition, the display means may also display at least one main permanent icon independently of the current situation of the aircraft. By way of example, each main permanent icon may relate to a state, to measurements, or indeed to the position of the aircraft. The selection means relating to the display means then make it possible to select a main permanent icon and then drag it sideways in order to display on the display means a main page of information linked to the selected main permanent icon.

The pilot thus drags the main contextual icon onto one of the previously-displayed pages of information and the device of the invention for assisting the piloting of an aircraft then displays the main page of information linked to the selected main permanent icon. This main page of information linked to the selected main permanent icon is displayed as a replacement for the page of information previously displayed on the display means.

Furthermore, the display means can display at least one secondary permanent icon independently of the current situation of the aircraft. The selection means relating to this display means then enable a secondary permanent icon to be selected in order to display a secondary page of information corresponding to the selected secondary permanent icon, possibly together with at least one secondary permanent icon. Each secondary permanent icon relates to the main page of information or else to the displayed secondary page of information. The secondary page of information linked to the selected secondary permanent icon is displayed as a replacement for the previously-displayed page of information.

The main and secondary permanent icons are linked to permanent links of a primary tree structure of the main and secondary pages of information.

This simple and predefined primary tree structure corresponds to the main and secondary pages of information being organized and classified in logical and hierarchical manner as is conventionally done in an aircraft. The pages of information are classified on the basis of main pages of information situated at a main level of the primary tree structure, and of secondary pages of information situated at secondary levels of the primary tree structure.

Main permanent links provide access to the main pages of information. A main permanent link is linked to a single main page of information and a main page of information is linked to a single main permanent link. Secondary permanent links connect the main pages of information to secondary pages of information, and they also connect together secondary pages of information.

In contrast, a main page of information may be connected by a plurality of secondary permanent links to a plurality of secondary pages of information, whereas a secondary page of information is connected by a single secondary permanent link to a single main page of information. Likewise, a secondary page of information situated at a secondary level n may be connected by a plurality of secondary permanent links to other secondary pages of information situated at a higher secondary level n+1. Conversely, a secondary page of information situated at a secondary level n is connected by a single secondary permanent link to a single secondary page of information situated at a lower secondary level n−1.

Two pages of information can thus be connected together firstly by a main or a secondary permanent link and secondly by a main or a secondary contextual link. Nevertheless, the permanent and contextual links are independent.

A main permanent link necessarily connects a main page of information to the origin of the tree structure. A secondary permanent link may be used equally well to connect a main page of information to a secondary page of information situated to a first secondary level, or else to connect together two secondary pages of information that are situated at two successive secondary levels.

In contrast, a contextual link, whether main or secondary, connects together two pages of information, preferably two secondary pages of information, regardless of their secondary levels. These two secondary pages of information may in particular be at the same secondary level or at they may be at two secondary levels that are not successive.

The main and secondary permanent links and the main and secondary contextual links may be stored together with the pages of information in the first database.

Preferably, the main and secondary permanent links are grouped together in a first library, while the main and secondary contextual links are grouped together in a plurality of second libraries. Advantageously, each second library of contextual links is thus attached to an event of the current situation of the aircraft, and an event is attached to a single second library. As a result, each second library has only one main contextual link and one or more secondary contextual links.

The first library may also have the main permanent icons and the secondary permanent icons that are attached to these main and secondary permanent links. Thus, the permanent links of the first library provide structured and hierarchical browsing firstly between each main permanent icon and each main page of information, and secondly between each secondary permanent icon and each secondary page of information.

Likewise, the second libraries may also have the main contextual icons and the secondary contextual icons that are attached to these main and secondary contextual links. Thus, the contextual links of each second library provide fast and permanent browsing between each main contextual icon and a pertinent page of information, and secondly between each secondary contextual icon and a pertinent page of information, as a function of the events of the current situation of the aircraft.

A memory of the device of the invention for assisting the piloting of an aircraft thus contains the first library of permanent links and the second libraries of contextual links, the first library and the second libraries possibly being stored in a single database or else in two dedicated databases.

The main and secondary permanent links and the main and secondary contextual links are preferably created when putting the pages of information into place in the memory of the device of the invention for assisting the piloting of an aircraft. These main and contextual links may also be modified when updating pages of information or indeed when changing equipment of the aircraft.

Furthermore, a single display means may be associated with a plurality of users, namely the pilot and the copilot, thus advantageously enabling the display means to be shared between those users. Under such circumstances, the use of touch display means enables the device of the invention for assisting the piloting of an aircraft to be used equally well by the pilot or by the copilot without any need to exchange selection means, since the selection means are incorporated in the display means.

In this way, the pages of information are shared by the pilot and the copilot, thus limiting the number of display means needed for effective and safe management of the flight of the aircraft by the pilot and the copilot.

In addition, the main contextual icons, and where appropriate the main permanent icons, are preferably displayed on the display means in a column that is situated between the two pages of information. This arrangement advantageously enables the pilot and the copilot to select icons easily while limiting the area they occupy on the display means, each icon being displayed once only. As a result, the major part of the area of the display means can be used for displaying two pages of information.

Each secondary permanent icon is preferably displayed on a main page of information and/or on a secondary page of information. Likewise, each secondary contextual icon is preferably displayed on a secondary page of information. Thus, this column groups together only main permanent and contextual icons, whereas the secondary permanent and contextual icons are displayed directly on pages of information. A distinction is thus clearly defined without risk of error between firstly main icons, whether permanent or contextual, and secondly secondary icons, whether permanent or contextual.

When displaying a page of information relating to an event of the current situation of the aircraft, selecting this column and then dragging this column sideways by means of the selection means enables two pages of information relating to the event to be displayed side by side. The pilot can advantageously consult two pages of information relating to the event simultaneously.

Furthermore, the display of certain pages of information can be enlarged by selecting the column and then dragging it sideways. This applies in particular when the page of information is displayed as a result of selecting a main or secondary permanent icon or indeed when the page of information shows the position of the aircraft on a map, or a representation of the environment of the aircraft. This can also apply when the page of information is a view from a camera outside the aircraft.

The present invention also provides a method of assisting the piloting of an aircraft. The aircraft includes in particular a processor, at least one display means, at least one selection means for each display means, at least one memory containing at least one database, measurement and detection means, and at least one analysis means.

This method of the invention for assisting the piloting of an aircraft may also be performed by the above-described device for assisting the piloting of an aircraft, which device is then included in the aircraft.

This method of assisting the piloting of an aircraft includes the following steps:

displaying two pages of information on display means;

determining a current situation of the aircraft;

displaying on the display means at least one main contextual icon relating to the current situation of the aircraft, each main contextual icon relating to an event of the current situation of the aircraft;

selecting a main contextual icon and dragging it sideways; and

displaying on the display means a page of information corresponding to the event attached to the selected main contextual icon.

The method of the invention for assisting the piloting of an aircraft may also include the following additional steps:

displaying on the display means at least one secondary contextual icon, each secondary contextual icon corresponding to the event of the current situation of the aircraft to which the selected main contextual icon is attached;

selecting a secondary contextual icon; and

displaying on the display means a page of information corresponding to the selected secondary contextual icon and also to at least one of the secondary contextual icons.

The method of the invention for assisting the piloting of an aircraft may also include the following additional steps:

displaying on the display means at least one main permanent icon independently of the current situation of the aircraft;

selecting a main permanent icon; and

displaying on the display means a main page of information linked to the selected main permanent icon.

The method of the invention for assisting the piloting of an aircraft may also include the following various additional steps:

displaying on the display means at least one secondary permanent icon independently of the current situation of the aircraft, each secondary permanent icon relating to the main page of information or else to the displayed secondary page of information;

selecting a secondary permanent icon; and

displaying on the display means a secondary page of information corresponding to the selected permanent icon, optionally together with at least one of the secondary permanent icons.

The method of the invention for assisting the piloting of an aircraft may also include a preliminary step of creating main and secondary contextual links and main and secondary permanent links. The main and secondary permanent links are grouped together in a first library, and the main and secondary contextual links are grouped together in a plurality of second libraries. Each second library of contextual links is attached to an event that might be encountered by the aircraft.

The main and secondary contextual links are attached to events of the current situation of the aircraft, whereas the main and secondary permanent links are independent of such events of the current situation of the aircraft. Furthermore, the main and secondary permanent links are linked to the pages of information using a primary tree structure, whereas the main and secondary contextual links are linked to the same page of information independently of the primary tree structure. In addition, each page of information is linked to at least one main or secondary permanent link, whereas only some of the pages of information need to be linked to one or more main and/or secondary contextual links.

### BRIEF DESCRIPTION OF THE SEVERAL VIEWS OF THE DRAWINGS

The invention and its advantages appear in greater detail from the context of the following description of embodiments given by way of illustration and with reference to the accompanying figures, in which:

FIG. 1 shows an aircraft fitted with a piloting assistance device;

FIG. 2 represents pages of information in a primary tree structure;

FIG. 3 represents pages of information in a primary tree structure with contextual links;

FIGS. 4 and 5 are two diagrams summarizing a method of assisting the piloting of an aircraft; and

FIGS. 6 to 9 are views of the display on display means.

Elements present in more than one of the figures are given the same references in each of them.

### DETAILED DESCRIPTION OF THE INVENTION

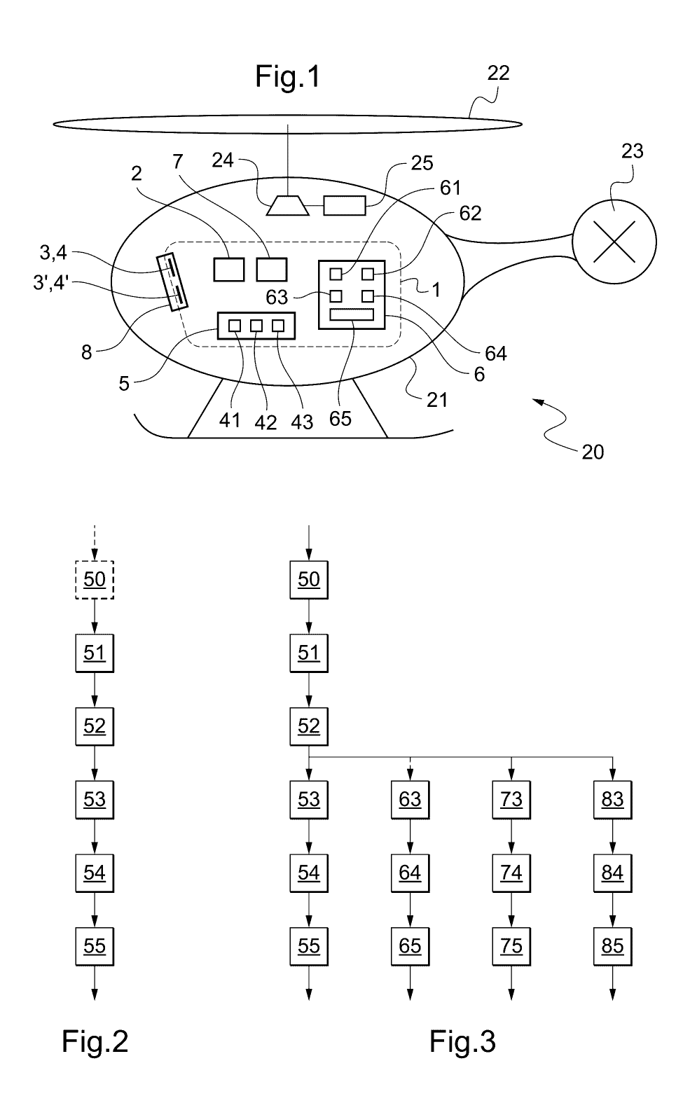

FIG. 1 shows an aircraft 20 comprising a fuselage 21, a main rotor 22, a tail rotor 23, a main mechanical power transmission gearbox 24, and an engine 25. The aircraft 20 also has an instrument panel 8 and a device 1 for assisting the piloting of. This piloting assistance device 1 comprises a processor 2, two touch screens 3, 3′ positioned on the instrument panel 8 and each including respective selector means 4, 4′, a memory 5, measurement and detection means 6, and analysis means 7. The memory 5 stores a plurality of databases 41, 42, 43.

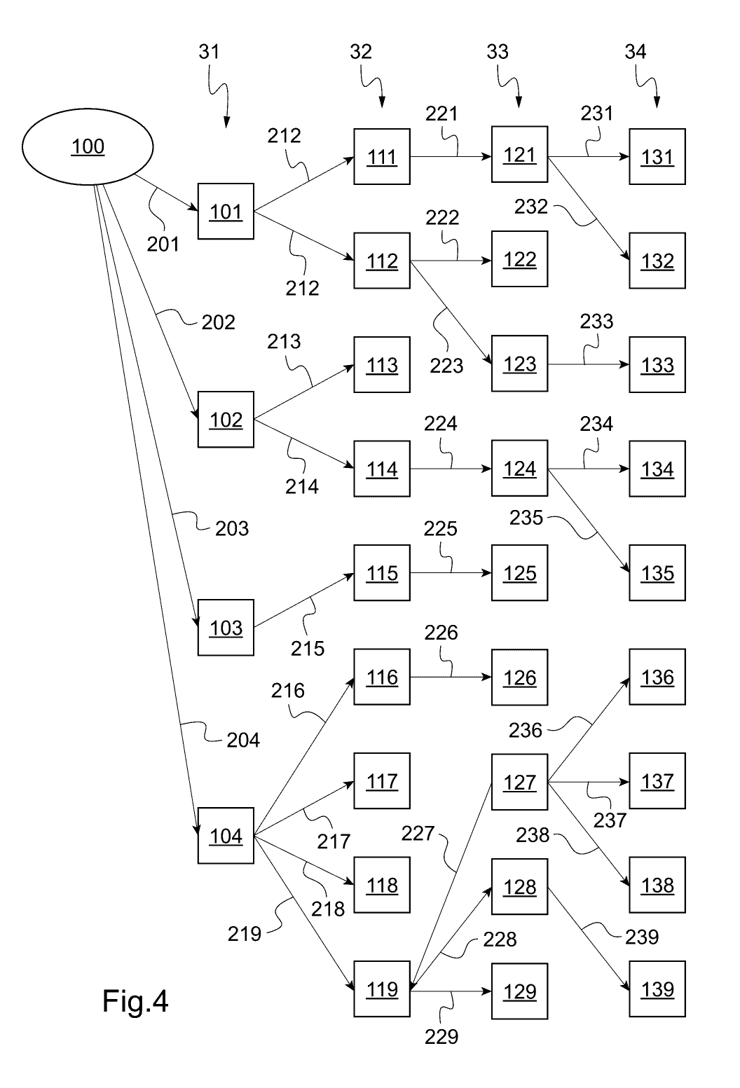

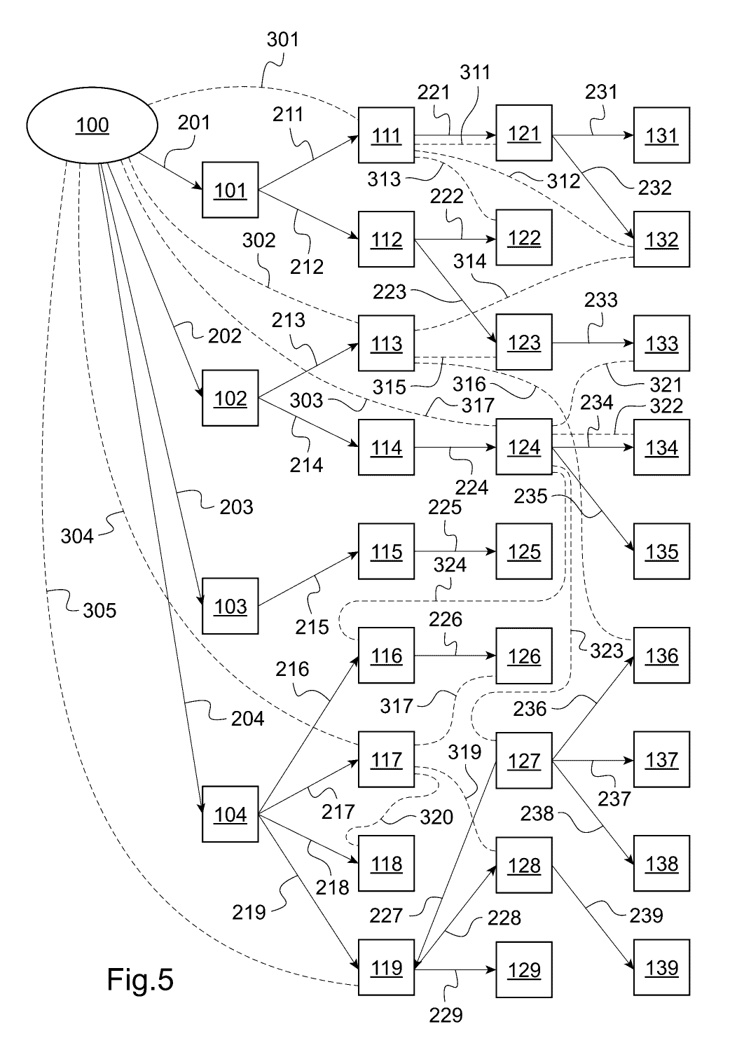

The device 1 for assisting the piloting of an aircraft is capable of performing a method of assisting the piloting of the aircraft 20. Two summary diagrams of such methods are shown in FIGS. 2 and 3.

In FIG. 2, the method of assisting the piloting of the aircraft 20 comprises five steps that take place sequentially.

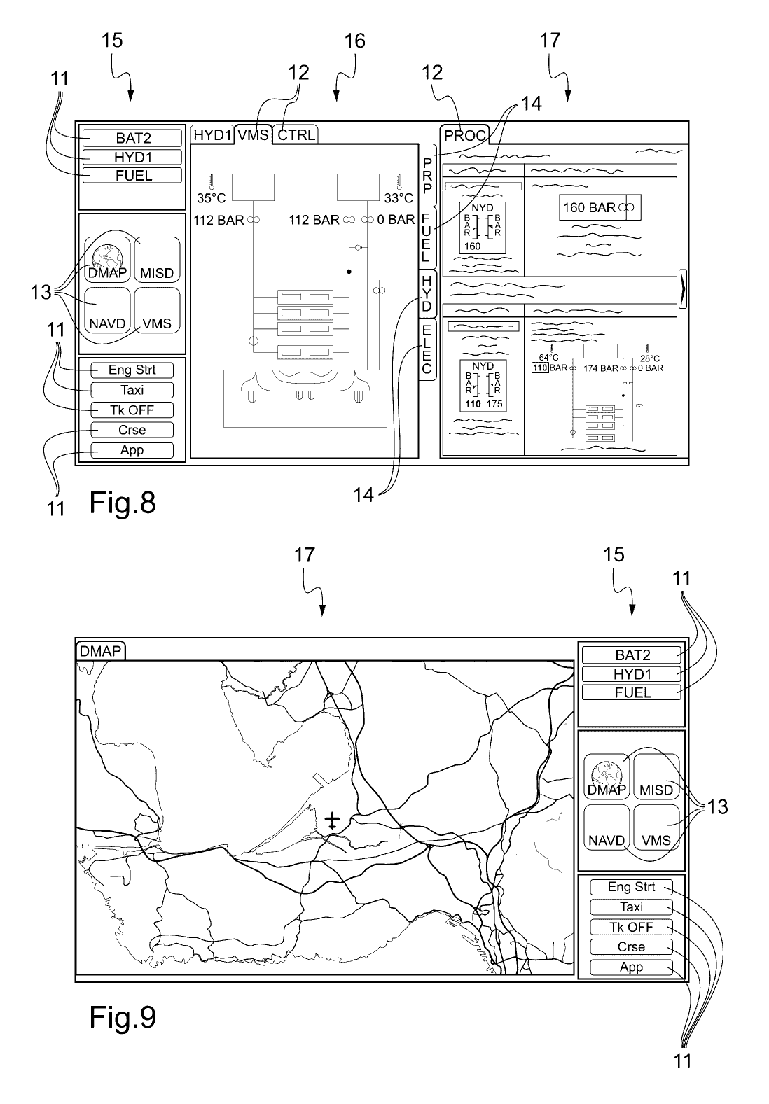

During a first step 51 of displaying two main and/or secondary pages 101-104 and/or 111-139 of information, two main pages 101-104 and/or two secondary pages 111-139 of information are displayed on one of the two touch screens 3, 3′, as shown in FIGS. 6 and 7. In FIG. 6, two main pages 101-104 of information are displayed respectively in a window 16 and in a window 17. In FIG. 7, a main page 101-104 of information is displayed in the window 16, and a secondary page 111-139 of information is displayed in the window 17.

The touch screens 3, 3′ are preferably positioned in the center of the instrument panel 8 so that they can be shared between the pilot and the copilot of the aircraft 20. The pilot and the copilot can thus take cognizance simultaneously of these main pages 101-104 and/or secondary pages 111-139 of information.

These main and secondary pages 101-104 and 111-139 of information are situated in a first database 41 stored in the memory 5. These main and secondary pages 101-104 and 111-139 of information contain a large amount of information necessary for managing the flight of the aircraft 20 and for operating its various pieces of equipment 21-25. These pages of information 101-104, 111-139 may in particular replace flight instruments as conventionally used and may provide information about the state of the aircraft 20, its equipment 21-25, or its environment.

This large amount of information is conventionally used in aircraft and is displayed on the screens of the instrument panels of such aircraft. The information is conventionally classified in hierarchical manner using a primary tree structure that is simple and predefined.

Furthermore, in the context of this method of assisting the piloting of the aircraft 20, the secondary pages 111-139 of information also include additional information such as the contents of the flight manual and of the user manuals of the aircraft 20 and of its equipment 21-25. This additional information could equally well be a list of tasks to be accomplished and/or procedures to be followed as a function of an event in the current situation of the aircraft 20.

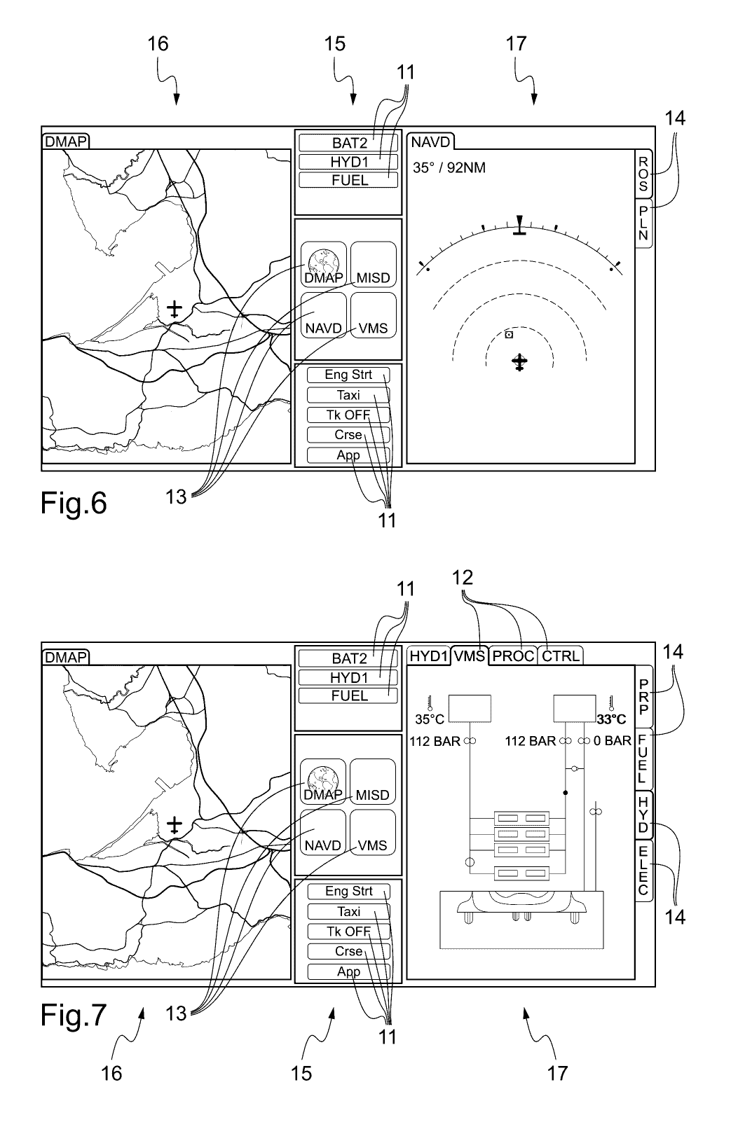

These main pages 101-104 and secondary pages 111-139 of information are thus linked to one another in a primary tree structure by main permanent links 201-204 and by secondary permanent links 211-239 in the form of a tree structure and branches, as shown in FIG. 4.

In this primary tree structure, the first database 41 has four main pages 101-104 of information and twenty-seven secondary pages 111-139 of information. The four main pages 101-104 of information are situated at a main level 31 of the primary tree structure and they are respectively connected by four main permanent links 201-204 to the origin 100 of this primary tree structure. The twenty-seven secondary pages 111-139 of information are situated on three secondary levels 32, 33, and 34.

Thus, each main page 101-104 of information is connected by one or more secondary permanent links 211-219 to one or more secondary pages 111-119 of information situated at the first secondary level 32. Likewise, a secondary page 111-119 of information situated at the first secondary level 32 is connected by one or more secondary permanent links 221-229 to one or more secondary pages 121-129 of information situated at the second secondary level 33. Finally, a secondary page 121-129 of information situated at the second secondary level 33 is connected by one or more secondary permanent links 231-239 to one or more secondary pages 131-139 of information situated at the third secondary level 34. Nevertheless, certain secondary pages 113, 117, 118, 122, 125, 126, and 129 of information are not connected to any secondary page of information at a higher secondary level. Furthermore, a secondary page 111-139 of information is connected to a single secondary page 111-139 of information at a secondary level that is lower or else to a single main page 101-104 of information.

The memory 5 thus stores the first database 41 comprising the main and secondary pages 101-104 and 111-139 of information together with a second database 42 comprising a first library grouping together the main permanent links 201-204 and the secondary permanent links 211-239.

Thereafter, during a second step 52 of determining the current situation of the aircraft 20, the analysis means 7 make use in real time of the measurements and/or information provided by the measurement and detection means 6 in order to determine the current situation of the aircraft 20.

The measurement and detection means 6 are constituted, among other things, by various sensors 61-64 in particular to determine the operating state of the aircraft 20, such as its air speed and its altitude. These sensors 61-64 also serve to determine the operating state of the equipment of the aircraft 20, such as the main rotor 22, the tail rotor 23, the main gearbox 24, and the engine 25. The measurement and detection means 6 also include a satellite receiver 65 for determining the speed and the position of the aircraft 20 in a terrestrial reference plane.

By way of example, the analysis means 7 can determine the stage of flight of the aircraft 20 or indeed any abnormal change to the current situation of the aircraft 20. The current situation of the aircraft 20 is made up of events such as maintaining a stage of flight or changing stage of flight during normal operation of the flight of the aircraft 20 or indeed an incident or a failure of a piece of equipment 21-25 in the event of an abnormal change to the current situation of the aircraft 20.

Main contextual links 301-305 and secondary contextual links 311-319 are attached to some of these events in the current situation of the aircraft 20. These main and secondary contextual links 301-305 and 311-319 are linked to secondary pages 111-139 of information, as shown in FIG. 5.

These secondary pages 111-139 of information linked to a main contextual link 301-305 or to a secondary contextual link 311-319 contain information that is pertinent relative to the event of the current situation of the aircraft 20 to which this main or secondary contextual link 301-305 or 311-319 is attached. These main and secondary contextual links 301-305 and 311-319 are linked to these secondary pages 111-139 of information independently of the primary tree structure. Specifically, a main contextual link 301-305 and a secondary contextual link 311-319 link together two secondary pages of information regardless of their secondary levels.

In contrast, the main and secondary permanent links 201-204 and 211-239 link the main and secondary pages 101-104 and 111-139 of information in a primary tree structure independently of such events in the current situation of the aircraft 20.

Furthermore, any one event in the current situation of the aircraft 20 is associated with a single main contextual link 301-305 and generally with one or more secondary contextual links 311-319. Nevertheless, it is possible for only one main contextual link 305 to be attached to an event without any secondary contextual link being attached to that event, as applies for the secondary page 119 of information. In addition, a main contextual link 301-305, or indeed a secondary contextual 311-319 may also be linked to a main page 101-104 of information.

The main contextual link 301-305 is set up to a secondary page 311-339 of information that is considered as being the page of information that is the most pertinent for the pilot in order to take account of and/or handle the event to which the main contextual link 301-305 is attached. This most pertinent secondary page 111-139 of information may be linked by at least one secondary contextual link 311-319 to at least one other secondary page of information that is also pertinent relative to the event.

The memory 5 stores a third database 43 containing second libraries grouping together these main contextual links 301-305 and these secondary contextual links 311-319. Each second library is attached to an event of the current situation of the aircraft 20.

The main and secondary permanent links 201-204 and 211-239 and also the main and secondary contextual links 301-305 and 311-319 may be created independently of the method of assisting the piloting of the aircraft 20 when putting pages of information into place in the first database 41.

Nevertheless, the method of providing assistance to piloting the aircraft 20 may include a preliminary step 50 of creating these main and secondary permanent links 201-204 and 211-239 and also these main and secondary contextual links 301-305 and 311-319. This preliminary step 50 is performed upstream of the first step 51.

During a third step 53 of displaying at least one main contextual icon 11, a plurality of main contextual icons 11 may be displayed on a touch screen 3, 3′, as shown in FIGS. 6 and 7. These main contextual icons 11 are displayed in a column 15 situated between the two pages of information, these two pages of information being displayed respectively in the windows 16 and 17 that are situated on either side of the column 15.

Each displayed main contextual icon 11 is linked to a main contextual link 301-305 of the second library and is thus attached to an event of the current situation of the aircraft 20. Specifically, a main contextual icon 11 is displayed on detecting an event of the current situation of the aircraft 20 to which a main contextual link is attached.

The main contextual icons 11 displayed at the bottom of the column 15 are main contextual icons concerning operation and they are attached to events relating to normal conduct of the flight of the aircraft 20. By way of example, these operational main contextual icons correspond to the stage of flight of the aircraft and to its position on the route specified by the flight plan.

The main contextual icons 11 displayed at the top of the column 15 are main contextual icons for providing alert and they are attached to events relating to an incident or to a failure of an essential piece of equipment 21-25 of the aircraft 20. The alerting main contextual icons 11 are displayed at the top of the column 15 in order to be more easily visible and identifiable by the pilot.

Each main contextual icon 11 may be associated with text or an abbreviation characterizing the event with which that main contextual icon 11 is attached.

During a fourth step 54 of selecting and dragging a main contextual icon 11 sideways, the pilot uses the selection means 4, 4′ to select a main contextual icon 11 on the touch screen 3, 3′. Since the selection means 4, 4′ is incorporated in the touch screen 3, 3′, the pilot presses a finger directly on the main contextual icon 11 on the touch screen 3, 3′. The pilot then drags the main contextual icon 11 sideways by moving that finger without leaving the touch screen 3, 3′. The selected main contextual icon 11 is dragged from the column 15 into one of the windows 16, 17.

Thereafter, during a fifth step 55 of displaying a secondary page 111-139 of information, a new secondary page 111-139 of information is displayed taking the place of the page of information that was previously displayed in the window 16, 17 to which the selected main contextual icon 11 has been dragged. This new displayed secondary page 111-139 of information is linked to the selected main contextual icon 11 and thus to the main contextual link 301-305 to which the selected main contextual icon is linked. Consequently, this new secondary page 111-139 of information that is displayed is likewise linked to the event of the current situation of the aircraft 20 to which this main contextual link 301-305 is attached. Finally, this new secondary page 111-139 of information is the page of information that is the most pertinent relative to the event.

After selecting and dragging a main contextual icon 11, the pilot of the aircraft 20 can thus easily and quickly consult the page of information that is the most pertinent relative to the event that corresponds to the appearance of this main contextual icon 11.

The method of providing assistance for piloting the aircraft 20 may include additional steps as shown in the summary diagram of FIG. 3. These additional steps may be grouped together as three steps taking place simultaneously with the third, fourth, and fifth steps 53, 54, and 55.

Firstly, the method of assisting the piloting of an aircraft 20 may include the following additional steps.

During a sixth step 63 of displaying at least one secondary contextual icon 12, a plurality of secondary contextual icons 12 may be displayed on the touch screen 3, 3′, as shown in FIG. 7. These secondary contextual icons 12 are displayed at the top of a secondary page 111-139 of information displayed in the window 17 and they correspond to an event of the current situation of the aircraft 20. By way of example, this secondary page 111-139 of information has been displayed as a result of a main contextual icon 11 being selected during the third step 53.

Each secondary contextual icon 12 that is displayed is linked to a secondary contextual link 311-319, which is itself attached to the event of the current situation of the aircraft 20 to which the secondary page 111-139 of information that is being displayed in the window 17 is linked.

Like the main contextual icons 11, each secondary contextual icon 12 may be associated with text or with an abbreviation.

Thereafter, during a seventh step 64 of selecting a secondary contextual icon 12, the pilot uses the selection means 4, 4′ to select a secondary contextual icon 12 on the touch screen 3, 3′.

During an eighth step 65 of displaying a secondary page 111-139 of information, a new secondary page 111-139 of information is displayed, taking the place of the secondary page 111-139 of information previously displayed in the window 17. This newly-displayed secondary page 111-139 of information is linked to the secondary contextual icon 12 selected in the preceding step, and thus to the secondary contextual link 311-319 to which the selected secondary contextual icon 12 is linked. Consequently, this newly-displayed secondary page 111-139 of information is likewise linked to the event of the current situation of the aircraft 20 that is linked to the secondary page 111-139 of information that was previously displayed in the window 17. This new secondary page 111-139 of information is thus also pertinent relative to this event so as to enable the pilot to handle the event.

The method of assisting the piloting of an aircraft 20 may also include the following additional steps.

During a ninth step 73 of displaying at least one main permanent icon 13, a plurality of main permanent icons 13 may be displayed on the touch screen 3, 3′, as shown in FIGS. 6 and 7. These main permanent icons 13 are displayed in the column 15 so as to be substantially centered vertically in the column 15, whereas the main contextual icons 11 are displayed at the top and/or the bottom of the column 15. Furthermore, these main permanent icons 13 are substantially square in shape, whereas the main contextual icons 11 are in the shape of elongate rectangles. The pilot can thus easily distinguish the main permanent icons 13 and the main contextual icons 11.

Each displayed main permanent icon 13 is linked to a main permanent link 201-204 of the first library and is thus linked to the primary tree structure of the main and secondary pages 101-104 and 111-139 of information. In contrast, this main permanent icon is independent of any event of the current situation of the aircraft 20. Specifically, these main permanent icons 13 are displayed permanently regardless of the current situation of the aircraft 20.

During a tenth step 74 of selecting a main permanent icon 13, the pilot uses the selection means 4, 4′ to select a main permanent icon 13 on the touch screen 3, 3′ and drag this selected main permanent icon 13 sideways from the column 15 to one of the windows 16 and 17.

During an eleventh step 75 of displaying a main page 101-104 of information, a main page 101-104 of information is displayed taking the place of the page of information that was previously displayed in the window 16, 17 to which the selected main permanent icon 13 has been dragged. This displayed main page 101-104 of information is linked to the selected main permanent icon 13 and thus to the main permanent link 201-204 to which this selected main contextual icon 11 is linked.

After selecting and dragging a main permanent icon 11, the pilot of the aircraft 20 can thus easily and quickly consult one of the main pages 101-104 of information at the main level 31 of the primary tree structure.

Finally, the method of assisting the piloting of an aircraft 20 may include the following additional steps.

During a twelfth step 83 of displaying at least one secondary permanent icon 14, a plurality of secondary permanent icons 14 may be displayed on the touch screen 3, 3′, as shown in FIGS. 6 and 7. These secondary permanent icons 14 are displayed on the side of a main page 101-104 of information displayed in the window 17, as shown in FIG. 6, or else on one side of a secondary page 111-139 of information displayed in the window 17, as shown in FIG. 7.

Each displayed secondary permanent icon 14 is linked to a secondary permanent link 211-239 of the first library, and is thus linked to the primary tree structure of the main and secondary pages 101-104 and 111-139 of information. This secondary permanent icon 14 is thus independent of any event of the current situation of the aircraft 20.

During a thirteenth step 84 of selecting a secondary permanent icon 14, the pilot uses the selection means 4, 4′ to select a secondary permanent icon 14 on the touch screen 3, 3′.

During a fourteenth step 85 of displaying a secondary page 111-139 of information, a new secondary page 111-139 of information is displayed taking the place of the page of information that was previously displayed in the window 17, which might have been a main page 101-104 of information or a secondary page 111-139 of information. This newly-displayed secondary page 111-139 of information is linked to the selected secondary permanent icon 14 and thus to the secondary permanent links 211-239 to which this selected secondary contextual icon 14 is linked.

After selecting a secondary permanent icon 14, the pilot of the aircraft 20 can thus easily and quickly consult a secondary page 111-139 of information at the first secondary level 32 of the primary tree structure when the previously-displayed page of information is a main page 101-104 of information, or else at a secondary level 33, 34 that is greater than the secondary level of the previously-displayed page of information when that previously-displayed page of information is a secondary page 111-139 of information.

In addition, it is possible to display two secondary pages 111-139 of information relating to the same event of the current situation of the aircraft 20 side by side, as shown in FIG. 8. For this purpose, when a secondary page 111-139 of information relating to an event of the current situation of the aircraft 20 is displayed in the window 17, for example, the pilot selects the column and then drags the column sideways to the window 17. The two windows 16 and 17 are then displayed side by side and the column 15 is displayed on one side of the touch screen 3, 3′. One of the two windows 16, 17 contains the previously-displayed secondary page 111-139 of information relating to the event, while the other window 16, 17 contains another secondary page 111-139 of information relating to the same event. The pilot can naturally request the display of another secondary page 111-139 of information relating to the same event by selecting a secondary contextual icon 12.

Furthermore, and as shown in FIG. 9, the display of certain pages 101-104, 111-139 of information can be enlarged by selecting the column 15, and then dragging it sideways. This applies in particular when the page 101-104, 111-139 of information is displayed as a result of selecting a main or secondary permanent icon 201-204 or 211-239, e.g. in order to display the position of the aircraft 20 on a map.

Naturally, the present invention may be subjected to numerous variations as to its implementation. Although several embodiments are described, it will readily be understood that it is not conceivable to identify exhaustively all possible embodiments. It is naturally possible to envisage replacing any of the means described by equivalent means without going beyond the ambit of the present invention.

What is claimed is:

1. A device for assisting the piloting of an aircraft, the device comprising:
at least one processor;
at least one display means;
selection means for each display means;
at least one memory containing at least one database;
measurement and detection means; and
at least one analysis means;
the measurement and detection means and at least one analysis means determining a current situation of the aircraft;
at least one display means displaying two pages of information, and at least one main contextual icon, each main contextual icon corresponding to an event of the current situation of aircraft; and
the selection means of the display means on which at least one main contextual icon is displayed enabling a main contextual icon to be selected and then dragged sideways in order to display on the display means a page of information linked to the selected main contextual icon and attached to an event of the current situation;
wherein the memory contains a first library of main and secondary permanent links and a plurality of second libraries of main and secondary contextual links, each second library of contextual links being attached to an event of the current situation of the aircraft, the main and secondary permanent links of the first library being linked respectively to main and secondary permanent icons and serving to browse firstly between each main permanent icon and a main page of information, and secondly between each secondary permanent icon and a secondary page of information, the main and secondary contextual links of each second library being linked respectively to the main and secondary contextual icons and serving to browse firstly between each main contextual icon and each page of information, and secondly between each secondary contextual icon and each page of information as a function of the current situation.

2. A device according to claim 1, wherein:
the display means displays at least one secondary contextual icon on the page of information linked to the selected main contextual icon, each secondary contextual icon corresponding to the event of the current situation to which the selected main contextual icon is attached; and
the selection means relating to the display means enables a secondary contextual icon to be selected in order to display on the display means a page of information corresponding to the selected secondary contextual icon and each of the other secondary contextual icons.

3. A display according to claim 1, wherein:
at least one display means displays at least one main permanent icon independent of the current situation; and
the selection means relating to the display means enables a main permanent icon to be selected in order to display on the display means a corresponding main page of information linked to the selected main permanent icon.

4. A display according to claim 1, wherein:
at least one display means displays on a page of information at least one secondary permanent icon independently of the current situation, each secondary permanent icon relating to the page of information; and
the selection means relating to the display means on which at least one secondary permanent icon is displayed enables a secondary permanent icon to be selected in order to display a secondary page of information corresponding to the selected secondary permanent icon, optionally together with at least one of the secondary permanent icons.

5. A display according to claim 1, wherein at least one display means is a touch screen, thus incorporating the selection means relating to the display means.

6. A method of assisting the piloting of an aircraft, the aircraft comprising:
at least one processor;
at least one display means;
selection means for each display means;
at least one memory containing at least one database;
measurement and detection means; and
at least one analysis means;
wherein the method includes a plurality of steps comprising:
creating firstly main and secondary contextual links attached to events of a current situation of the aircraft and linked to pages of information, and secondly main and secondary permanent links independent of the event of the current situation of the aircraft and linked to pages of information in a primary tree structure, the main and secondary permanent links being grouped together in a first library and the main and secondary contextual links being grouped together in a plurality of second libraries, each second library of contextual links being attached to an event that can be encountered by the aircraft;
displaying two pages of information on display means;
determining a current situation of the aircraft;
displaying on the display means at least one main contextual icon relating to the current situation, each main contextual icon relating to an event of the current situation of the aircraft;
selecting a main contextual icon and dragging it sideways; and
displaying on the display means a page of information corresponding to the event attached to the selected main contextual icon.

7. A method of assisting the piloting of an aircraft according to claim 6, wherein the method includes various additional steps comprising:
displaying on the display means at least one secondary contextual icon corresponding to the event of the current situation to which the selected main contextual icon is attached;
selecting a secondary contextual icon; and
displaying on the display means a page of information corresponding to the selected secondary contextual icon and also to at least one of the secondary contextual icons.

8. A method of assisting the piloting of an aircraft according to claim 6, wherein the method includes various additional steps comprising:
displaying on the display means at least one main permanent icon independently of the current situation;
selecting a main permanent icon; and
displaying on the display means a corresponding main page of information linked to the selected main permanent icon.

9. A method of assisting the piloting of an aircraft according to claim 6, wherein the method includes various additional steps, comprising:
displaying on the display means on a page of information, at least one secondary permanent icon independently of the current situation of the aircraft, each secondary permanent icon relating to the page of information;
selecting a secondary permanent icon; and
displaying on the display means a secondary page of information corresponding to the selected secondary permanent icon, optionally together with at least one of the secondary permanent icons.

10. A method of assisting the piloting of an aircraft according to claim 6, wherein the main contextual icons, and where applicable the main permanent icons, are displayed on the display means in a column situated between the pages of information.

11. A method of assisting the piloting of an aircraft according to claim 10, wherein two secondary pages of information relating to the event attached to the selected main contextual icon are displayed side by side on the display means by selecting the column and then dragging it sideways.

12. A method of assisting the piloting of an aircraft according to claim 10, wherein the display of a page of information is enlarged on the display means by selecting the column and then dragging it sideways.

13. A method of assisting the piloting of an aircraft according to claim 6, wherein the display means is a touch screen thus incorporating the selection means relating to the display means.
